(19) United States
(12) Patent Application Publication
(10) Pub. No.: US 2018/0014660 A1
(43) Pub. Date: Jan. 18, 2018

(54) BED FRAME AND BED

(71) Applicant: IWATA Co., Ltd., Kyoto-shi (JP)

(72) Inventors: Arichika IWATA, Kyoto (JP); Shinichi ISHIKAWA, Kyoto (JP); Koichiro ZAMMA, Nagano (JP)

(21) Appl. No.: 15/648,270

(22) Filed: Jul. 12, 2017

(30) Foreign Application Priority Data
Jul. 13, 2016 (JP) 2016-138345

(51) Int. Cl. A47D 9/02; A47C 19/02; A01K 1/015

(52) U.S. Cl. CPC A47D 9/02; A01K 1/015; A47C 19/02

(57) ABSTRACT

A bed frame includes: a leg that can be rocked in a radiation direction; and a support that is connected onto the leg and supports a body of a user. A bed includes: the bed frame; and a mattress that is placed on the support of the bed frame. The mattress has a substantially same shape as the support when viewed from above. The mattress includes: a body section; and a pillow section that extends along a periphery of the body section.

### CROSS REFERENCE TO RELATED APPLICATIONS

This application claims the benefit of Japanese Patent Application No. 2016-138345 filed on Jul. 13, 2016, the disclosure of which is incorporated herein by reference.

### BACKGROUND OF THE INVENTION

### 1. Field of the Invention

The present invention relates to a bed frame and a bed equipped with the same.

### 2. Description of the Related Art

Beds having rocking function have been developed in the related art, so as to give a user sleeping comfort.

Japanese Unexamined Utility Model Application Publication No. S62-055961 (to be referred to as Patent Document 1 hereinafter) discloses, for example, an invention of a bed having a lower end made up of a plurality of arc-shaped plates with a downward convex. According to the art, the bed can be rocked when a user shifts his/her body center of gravity in a direction in which the plates extend.

### PATENT DOCUMENT

[Patent Document 1] Japanese Unexamined Utility Model Application Publication No. S62-055961

### SUMMARY OF THE INVENTION

In the bed according to the invention of Patent Document 1, however, a plurality of the plates extend in the same direction, which allows the bed to be rocked in only one direction.

The present invention has been thus made in light of a point of view as described above and in an attempt to provide: a bed frame which can be rocked in a radiation direction; and a bed equipped with the bed frame.

In accordance with a first aspect of the present invention, a bed frame includes: a leg that can be rocked in a radiation direction; and a support that is connected onto the leg and supports a body of a user.

The bed frame in accordance with the first aspect includes the leg that can be rocked in the radiation direction. The bed frame rockable in the radiation direction can give a user sleeping comfort.

In accordance with a second aspect of the present invention, the leg includes a plurality of contact members that cross each other and come into contact with a surface on which the bed is installed. At least a periphery of the support is connected to each of the contact members.

The bed frame in accordance with the second aspect can reduce the leg in weight and improve stability of the bed frame.

In accordance with a third aspect of the present invention, the contact members make line contact with the respective installation surfaces.

The bed frame in accordance with the third aspect thus has a small contact area between each of the contact members and the installation surface. This can prevent the bed from rattling and achieve a smooth rocking of the bed.

In accordance with a fourth aspect of the present invention, the leg extends more outwardly than a circumferential edge of the support when viewed from above.

This can prevent the bed frame in accordance with the fourth aspect from overturning and improve stability of the bed.

In accordance with a fifth aspect of the present invention, the support includes: a frame part that is connected to the leg; and a receive part that is disposed inside the frame part, is concaved more downwardly than the frame part, and is flexible.

This can make the receive part deformable in accordance with a body type or a sleep posture of the user and can thus softly receive the user's body.

In accordance with a sixth aspect of the present invention, a bed includes: the bed frame in accordance with any one of the first to fifth aspects of the present invention; and a mattress that is disposed on the support of the bed frame. The mattress has a shape substantially same as that of the support when viewed from above. The mattress includes: a body section; and a pillow section that extends along a whole circumference of the body section.

In accordance with the sixth aspect, the mattress integrally includes the pillow section. This can prevent slippage of the pillow section. Further, the pillow section extends along a periphery of the mattress. This makes it easy for the user to sleep with his/her head on the pillow section, even when the user changes his/her sleep posture. Further, the pillow section extends along the circumference of the mattress. This makes it possible for a user to put his/her head, and legs and feet on the pillow section 32 such that his/her head, and legs and feet are positioned higher than his/her trunk, which allows the user to keep lying in a comfortable position.

The bed frame and the bed in accordance with the first to sixth aspects of the present invention can be rocked in the radiation direction.

### BRIEF DESCRIPTION OF THE DRAWINGS

FIG. 1 is an exploded perspective diagram illustrating a bed according to an embodiment of the present invention.

FIG. 2 is an exploded perspective diagram illustrating a bed frame according to the embodiment.

FIG. 3 is a plan view illustrating the bed frame according to the embodiment.

FIG. 4 is a schematic cross sectional diagram illustrating the bed frame when cut along the line IV-IV of FIG. 3.

FIG. 5 is a cross sectional diagram illustrating the bed frame when cut along the line V-V of FIG. 4.

FIG. 6 is a schematic cross sectional diagram illustrating the bed frame when cut along the line VI-VI of FIG. 3.

FIG. 7 is a schematic cross sectional diagram illustrating the bed frame when cut along the line VII-VII of FIG. 3.

FIG. 8 is a schematic cross sectional diagram illustrating the bed frame when cut along the line VIII-VIII of FIG. 3.

FIG. 9 is a plan view illustrating a state where a mattress is placed on the bed frame of FIG. 2.

FIG. 10 is a schematic cross sectional diagram illustrating the bed frame when cut along the line X-X of FIG. 9.

FIG. 11 is an explanatory diagram for explaining how the bed is rocked according to the embodiment.

FIG. 12 is a plan view illustrating a bed frame according to a variation of the present invention.

FIG. 13 is a schematic cross sectional diagram illustrating a bed frame according to another variation.

### DETAILED DESCRIPTION OF THE EMBODIMENTS

Embodiments of the present invention are described in detail with reference to the related drawings. In the explanation, the same reference numerals are given to the same components and description thereof is omitted herefrom.

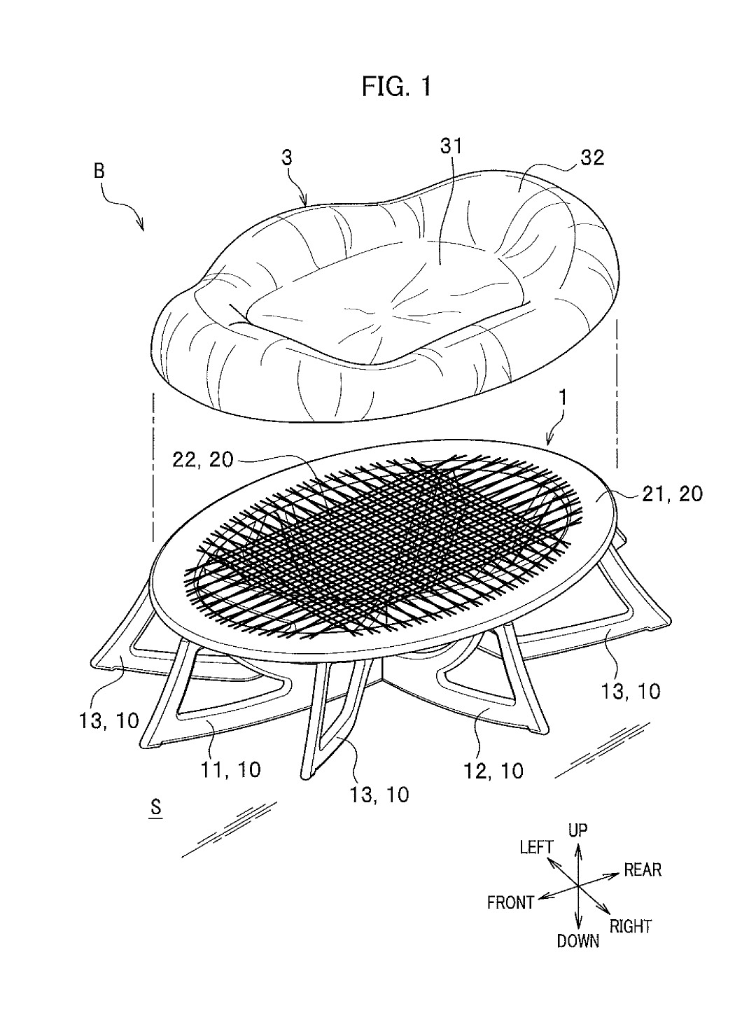

As illustrated in FIG. 1, a bed B according to an embodiment of the present invention includes: a bed frame 1; and a mattress 3 that is placed on the bed frame 1. The bed B has an oval shape as a whole when viewed from above. In this embodiment, a case is described as an example, in which the bed B is installed on a floor S in a room. Description of the example is not, however, intended to limit where to place the bed B.

In the explanation below, a major axis direction of the bed B is referred to as a front-back direction; a minor axis direction, a right-left direction; and a direction perpendicular to both the major axis direction and the minor axis direction of the bed B, an up-down direction. Further, a center side of the bed B is referred to as inward; and a side away from the center of the bed B, outward.

The bed frame 1 includes: a leg 10 that can be rocked radially with respect to the floor S; and a support 20 that is jointed onto the leg 10 and supports a body of a user not shown.

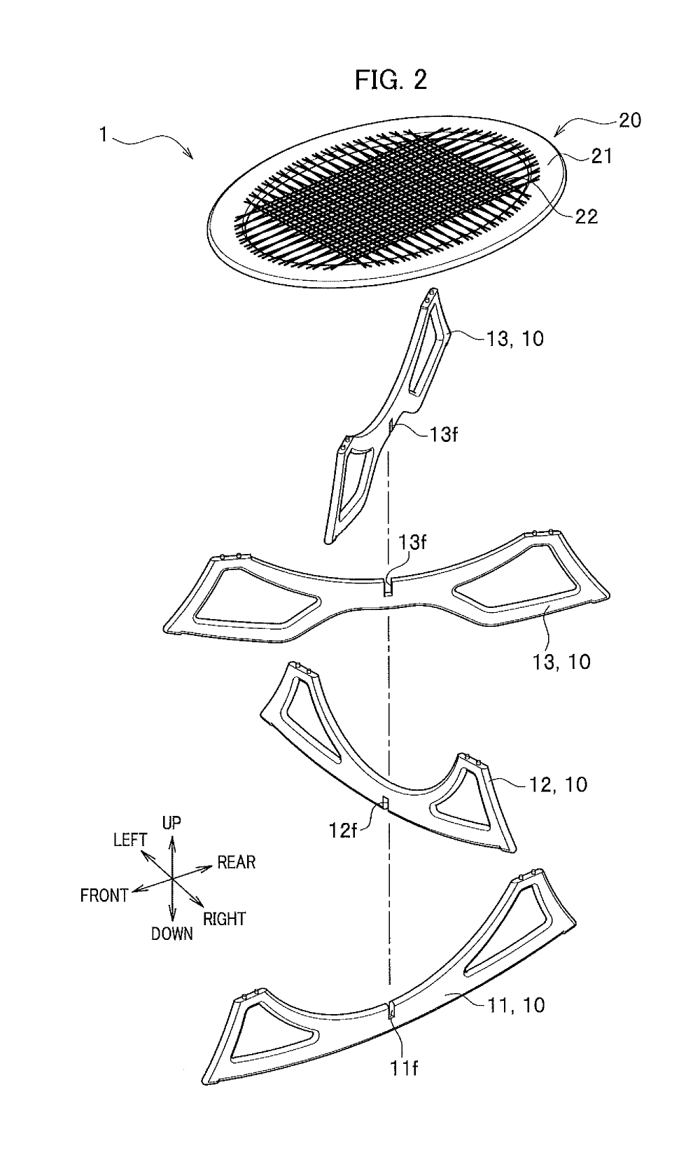

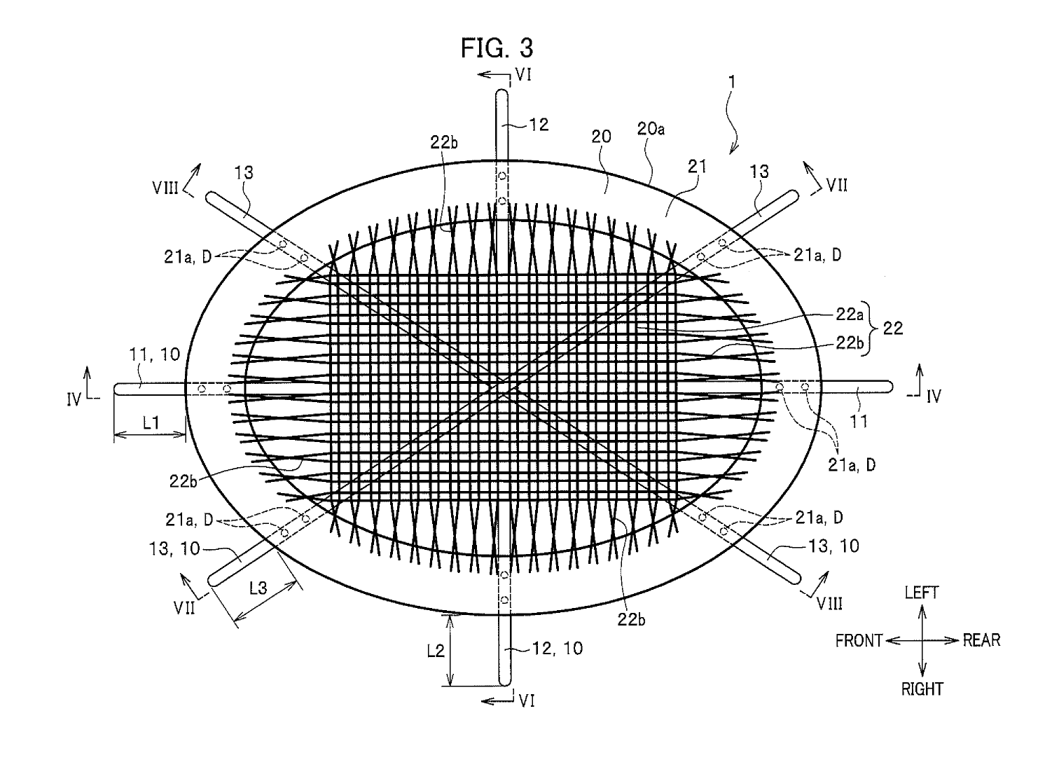

As illustrated in FIG. 2, the leg 10 according to the embodiment includes: a lengthwise plate member 11; a crosswise plate member 12, the plate members 11, 12, crossing each other; and a pair of diagonal plate members 13, 13. The lengthwise plate member 11, the crosswise plate member 12, and a pair of the diagonal plate members 13, 13 may each also be referred to as a “contact member”. As illustrated in FIG. 3, each of the plate members 11 to 13 protrudes beyond a circumferential edge 20a of the support 20 when viewed from above. Projected dimensions L1-L3 of the respective plate members 11 to 13 are not specifically limited, and are herein set at 200 mm, for example. In this embodiment, the plate members 11 to 13 are made of medium density fiberboard (MDF). The plate members 11 to 13 may be, however, made of wood, resin, metal, or any other material and are preferably made of strong light material. The number of the plate members may be increased or reduced where appropriate.

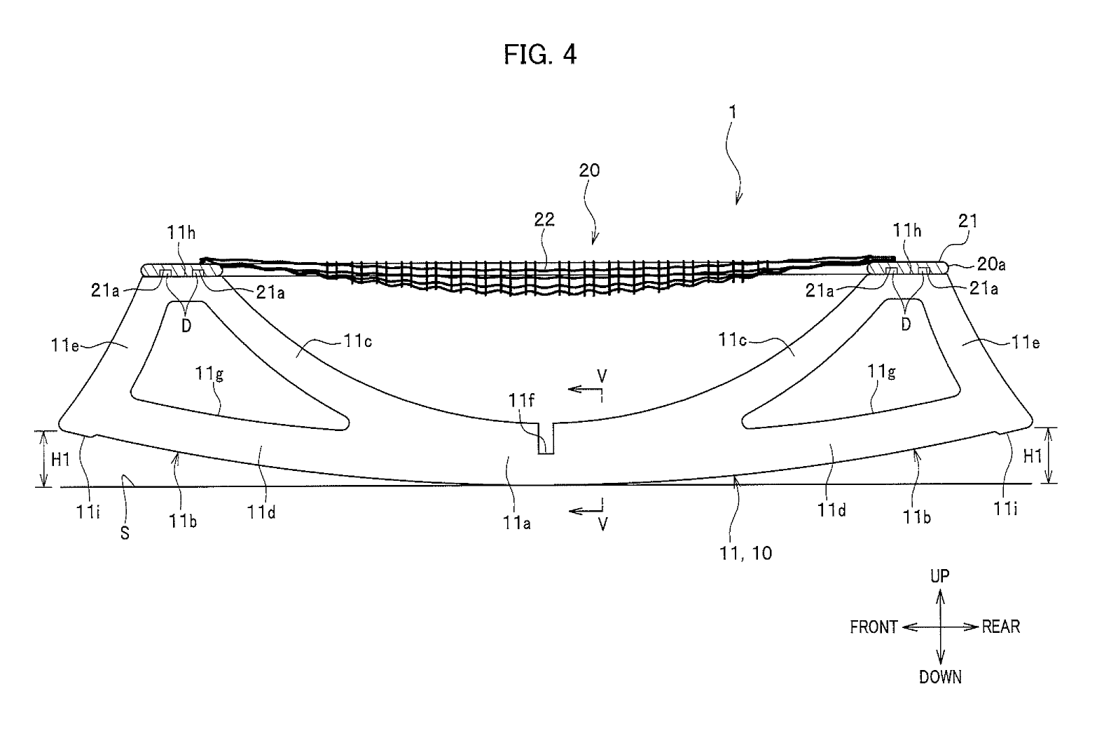

As illustrated in FIG. 4, the lengthwise plate member 11 extends in the front-back direction (the major axis direction). The lengthwise plate member 11 comes into contact with the floor S and has functions of both rocking the bed B and preventing the bed B from overturning. The lengthwise plate member 11 has an arcuate shape with a downward convex as a whole. The lengthwise plate member 11 includes: a lengthwise base part 11a; and a pair of lengthwise restriction parts 11b, 11 b which extend outwardly from both outer ends of the lengthwise base part 11a. The lengthwise plate member 11 is formed axisymmetrically with respect to a vertical axis passing through the center.

The lengthwise base part 11a is situated in a middle of the lengthwise plate member 11 and comes into contact with the floor S when the bed B is in an initial position (a horizontal position). The lengthwise base part 11a extends in the front-back direction, keeping a substantially same height dimension. A notched portion 11f having a rectangle shape when viewed from the front is formed at a center on an upper end of the lengthwise base part 11a. The notched portion 11f opens upwardly.

The lengthwise restriction part 11b prevents the bed frame 1 from rocking at a prescribed angle or larger and is jointed to the support 20. The lengthwise restriction part 11b has a height dimension larger than that of the lengthwise base part 11a. The lengthwise restriction part 11b has a substantially triangle shaped bored-out hole 11g for reduction in weight. Each of a pair of the lengthwise restriction parts 11b, 11b includes: an upper diagonal part 11c and a lower diagonal part 11d that are branched up and down across the bored-out hole 11g, respectively, from an outer end of the lengthwise base part 11a; and an outer part 11e that joints respective outer ends of the upper diagonal part 11c and the lower diagonal part 11d.

The more outwardly, the more upwardly the upper diagonal part 11c is inclined. An upper end of the upper diagonal part 11c and the upper end of the lengthwise base part 11a are integrally connected without irregularities therebetween and are formed in an arcuate shape with a downward convex as a whole.

The more outwardly, the more upwardly the lower diagonal part 11d is inclined, though the less upwardly than the upper diagonal part 11c. The outer end of the lower diagonal part 11d is positioned more outwardly than the outer end of the upper diagonal part 11c when viewed from above. A lower end of the lower diagonal part 11d and a lower end of the lengthwise base part 11a are integrally connected without irregularities therebetween and are formed in an arcuate shape with a downward convex as a whole. The more outwardly, the larger a distance between the integrated lower ends of the lengthwise base part 11a and the lower diagonal part 11d, and the floor S.

The outer part 11e extends horizontally and outwardly from the outer end of the upper diagonal part 11c, and then extends obliquely downwardly toward the lower diagonal part 11d. A flat joint surface 11h is formed on the upper end of the outer part 11e. A plurality of dowels D (in this embodiment, two) which fit into respective dowel holes 21a in a frame part 21 protrude upwardly into the joint surface 11h.

The more downwardly, the more outwardly the outer end of the outer part 11e is inclined and is formed in an arcuate shape with an inward convex. A contact part 11i is formed on the lower end of the outer part 11e and protrudes in a step shape more downwardly than the lower diagonal part 11d. The contact part 11i is a planar part which comes into contact with the floor S when the bed frame 1 is rocked at a prescribed angle or larger and gives a rattle (an uncomfortable feeling) to a user thereof. That is, the contact part 11i can call a user's attention in rocking the bed B. A height dimension H1 from the floor S to the contact part 11i defines a range within which the bed B can be rocked and is 100 mm, for example.

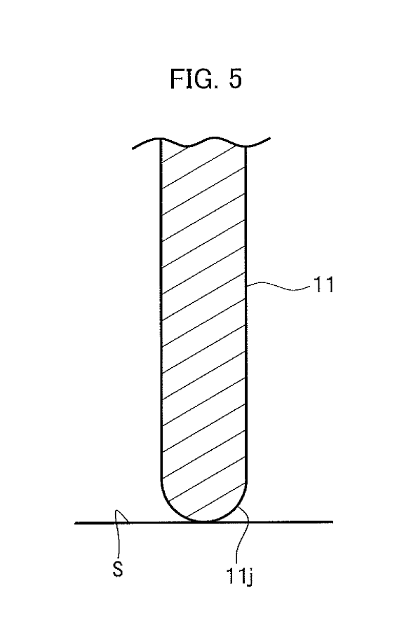

As illustrated in FIG. 5, a chamfered part 11j in an arcuate shape with a downward convex is formed along the entire length of the lower end of the lengthwise plate member 11. A top portion of the chamfered part 11j makes line contact with the floor S. A thickness of the lengthwise plate member 11 or a curvature of the chamfered part 11j can be changed where appropriate. Though not shown, the other plate members 12, 13 also have the lower ends with respective chamfered parts thereon. A top portion of each of the chamfered parts also makes line contact with the floor S.

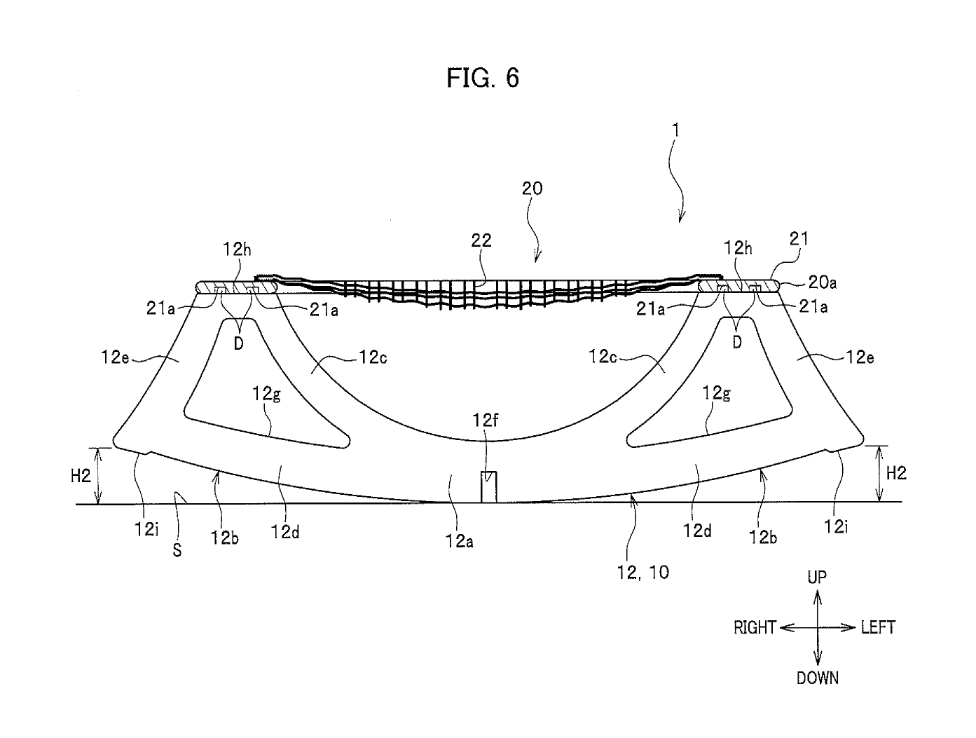

As illustrated in FIG. 3, the crosswise plate member 12 extends in the right-left direction (the minor axis direction) and is at right angles to the lengthwise plate member 11. That is, the lengthwise plate member 11 and the crosswise plate member 12 intersect in a cross shape when viewed from above. A length of the crosswise plate member 12 is made smaller than that of the lengthwise plate member 11. As illustrated in FIG. 6, the crosswise plate member 12 comes into contact with the floor S and has functions of both rocking the bed B and preventing the bed B from overturning. The crosswise plate member 12 has an arcuate shape with a downward convex as a whole. The crosswise plate member 12 includes: a lengthwise base part 12a; and a pair of lengthwise restriction parts 12b, 12b which extend outwardly from both outer ends of the lengthwise base part 12a. The crosswise plate member 12 is formed axisymmetrically with respect to a vertical axis passing through the center.

The crosswise base part 12a is situated in a middle of the crosswise plate member 12 and comes into contact with the floor S when the bed B is in an initial position. The crosswise base part 12a extends in the right-left direction, keeping a substantially same dimension. A notched portion 12f having a substantially rectangle shape when viewed from the front is formed at a center on a lower end of the crosswise base part 12a. The notched portion 12f opens downwardly. The lengthwise plate member 11 and the crosswise plate member 12 are jointed each other by insertion of the notched portions 11f, 12f in the up-down direction (see FIG. 2).

The crosswise restriction part 12b prevents the bed frame 1 from rocking at a prescribed angle or larger and is jointed to the support 20. The crosswise restriction part 12b has a height dimension larger than that of the crosswise base part 12a. The crosswise restriction part 12b has a substantially triangle shaped bored-out hole 12g for reduction in weight. Each of a pair of the crosswise restriction parts 12b, 12b includes: an upper diagonal part 12c and a lower diagonal part 12d that are branched up and down across the bored-out hole 12g, respectively, from an outer end of the crosswise base part 12a; and an outer part 12e that joints respective outer ends of the upper diagonal part 12c and the lower diagonal part 12d.

The more outwardly, the more upwardly the upper diagonal part 12c is inclined. The upper end of the upper diagonal part 12c and the upper end of the crosswise base part 12a are integrally connected without irregularities therebetween and are formed in an arcuate shape with a downward convex as a whole.

The more outwardly, the more upwardly the lower diagonal part 12d is inclined, though the less upwardly than the upper diagonal part 12c. The outer end of the lower diagonal part 12d is positioned more outwardly than the outer end of the upper diagonal part 12c when viewed from above. A lower end of the lower diagonal part 12d and a lower end of the crosswise base part 12a are integrally connected without irregularities therebetween and are formed in an arcuate shape with a downward convex as a whole. The more outwardly, the larger a distance between the integrated lower ends of the crosswise base part 12a and the lower diagonal part 12d, and the floor S.

The outer part 12e extends outwardly and horizontally from the outer end of the upper diagonal part 12c, and then extends obliquely downwardly toward the lower diagonal part 12d. A flat joint surface 12h is formed on the upper end of the outer part 12e. A plurality of dowels D (in this embodiment, two) which fit into respective dowel holes 21a in the frame part 21 protrude upwardly into the flat joint surface 12h.

The more downwardly, the more outwardly the outer end of the outer part 12e is inclined and is formed in an arcuate shape with an inward convex. A contact part 12i is formed on the lower end of the outer part 12e and protrudes in a step shape more downwardly than the lower diagonal part 12d. The contact part 12i is a planar part which comes into contact with the floor S when the bed frame 1 rocks at a prescribed angle or larger and gives a rattle (an uncomfortable feeling) to a user. That is, the contact part 12i can call a user's attention in rocking the bed B. A height dimension H2 from the floor S to the contact part 12i is set same as the height dimension H1.

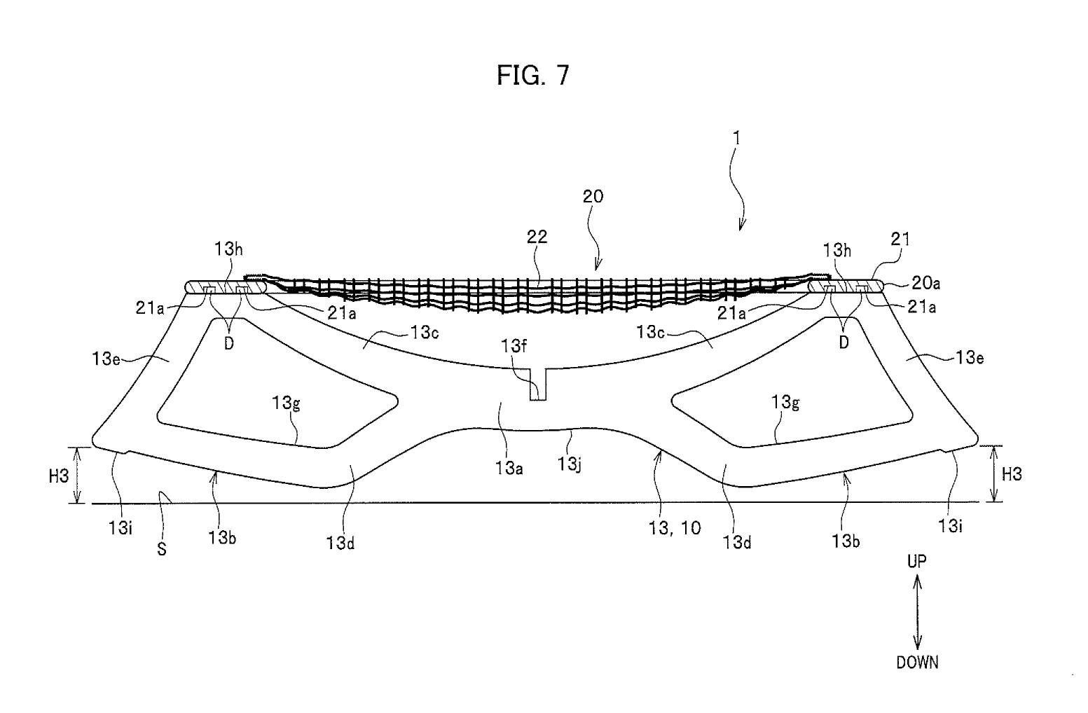

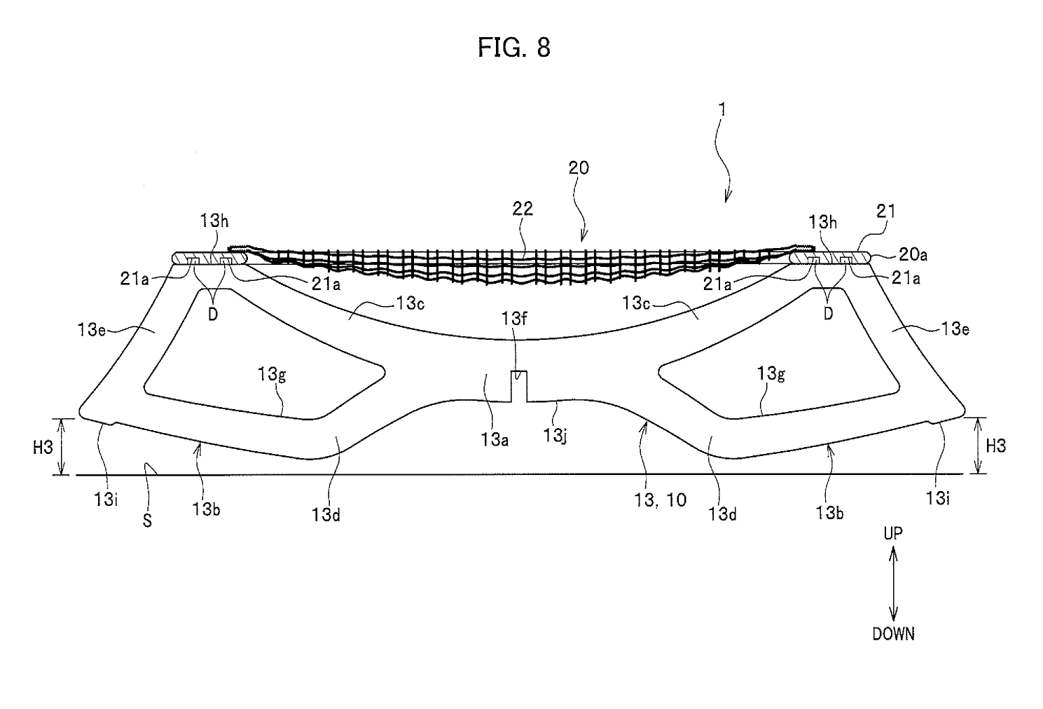

As illustrated in FIG. 3, a pair of the diagonal plate members 13, 13 are assembled in an X shape and make a prescribed angle to each of the lengthwise plate member 11 and the crosswise plate member 12. In the embodiment, respective angles made by the diagonal plate members 13, 13 and the lengthwise plate member 11 may be set as appropriate, and, in this embodiment, the angles are set at about 30 degrees. As illustrated in FIG. 7 and FIG. 8, the diagonal plate members 13, 13 are jointed to the support 20 in a position above and apart from the floor S when the bed B is in the initial position. When the bed B is obliquely inclined at a prescribed angle or larger, any of the diagonal plate members 13, 13 come into contact with the floor S and prevent the bed B from overturning. Each of the diagonal plate members 13, 13 has an arcuate shape with a downward convex as a whole.

Each of a pair of the diagonal plate members 13, 13 includes: a diagonal base part 13a; and a pair of diagonal restriction parts 13b, 13b which extend outwardly from both outer ends of the diagonal base part 13a. The diagonal plate member 13 is formed axisymmetrically with respect to a vertical axis passing through the center. A pair of the diagonal plate members 13, 13 have same structures except directions in which respective notched portions 13f, 13f open. Description below is thus made focusing on one of the diagonal plate member 13 illustrated in FIG. 7.

The diagonal base part 13a is situated in a middle of the diagonal plate member 13 and integrally connects a pair of the diagonal restriction parts 13b, 13b. The diagonal base part 13a extends keeping a substantially same height dimension. The notched portion 13f having a substantially rectangle shape when viewed from the front is formed at a center on an upper end of the diagonal base part 13a. The notched portion 13f opens upwardly. Meanwhile, the other notched portion 13f of the other diagonal plate member 13 illustrated in FIG. 8 opens downwardly at a center on a lower end of the other diagonal base part 13a. A pair of the diagonal plate members 13, 13 are jointed each other by insertion of the notched portions 13f, 13f in the up-down direction (see FIG. 2).

The diagonal restriction part 13b prevents the bed frame 1 from rocking at a prescribed angle or larger and is jointed to the support 20. The diagonal restriction part 13b has a height dimension larger than that of the diagonal base part 13a. The diagonal restriction part 13b has a substantially trapezoid shaped bored-out hole 13g for reduction in weight. Each of a pair of the diagonal restriction parts 13b, 13b includes: an upper diagonal part 13c and a lower diagonal part 13d that are branched up and down across a bored-out hole 13g, respectively, from an outer end of the diagonal base part 13a; and an outer part 13e that joints respective outer ends of the upper diagonal part 13c and the lower diagonal part 13d.

The more outwardly, the more upwardly the upper diagonal part 13c is inclined. The upper end of the upper diagonal part 13c and the upper end of the diagonal base part 13a are integrally connected without irregularities therebetween and are formed in an arcuate shape with a downward convex as a whole.

The more outwardly, the more downwardly the lower diagonal part 13d is inclined at first, and is then inclined upwardly. A lower end of the lower diagonal part 13d and a lower end of the diagonal base part 13a are integrally connected without irregularities therebetween. A concave portion 13j is cut out in an area ranging from the lower end of the diagonal base part 13a to an inflection point of the lower diagonal part 13d at which the lower diagonal part 13d turns from downward to upward, so as to avoid interfering with the lengthwise plate member 11 and the crosswise plate member 12. The lengthwise plate member 11 and the crosswise plate member 12 cross with each other, passing under the concave portion 13j. Any of a pair of the diagonal plate members 13, 13 are not jointed with the lengthwise plate member 11 or the crosswise plate member 12. The outer end of the lower diagonal part 13d is positioned more outwardly than the outer end of the upper diagonal part 13c when viewed from above.

The outer part 13e extends outwardly and horizontally from the outer end of the upper diagonal part 13c, and then extends obliquely downwardly toward the outer end of the lower diagonal part 13d. A flat joint surface 13h is formed on the upper end of the outer part 13e. A plurality of dowels D (in this embodiment, two) which fit into respective dowel holes 21a in the frame part 21 protrude upwardly into the flat joint surface 13h.

The more downwardly, the more outwardly the outer end of the outer part 13e is inclined and is formed in an arcuate shape with an inward convex. A contact part 13i is formed on the lower end of the outer part 13e and protrudes in a step shape more downwardly than the lower diagonal part 13d. The contact part 13i is a planar part which comes into contact with the floor S when the bed frame 1 is rocked at a prescribed angle or larger and gives a rattle (an uncomfortable feeling) to a user. That is, the contact part 13i can call a user's attention in rocking the bed B. A height dimension H3 from the floor S to the contact part 13i is set at a height same as the height dimensions H1, H2.

As illustrated in FIG. 3, the support 20 includes: the frame part 21 that is connected to the leg 10; and a receive part 22 that is disposed inside the frame part 21.

The frame part 21 constitutes a periphery of the support 20. The frame part 21 has an oval frame shaped when viewed from above. The frame part 21 is made of medium density fiberboard (MDF) in this embodiment. The frame part 21 may be made of, however, wood, resin, metal, or the like and is preferably made of strong light material. The frame part 21 has a plurality of dowel holes 21a, 21a formed thereon. A plurality of the dowel holes 21a, 21a are disposed spaced apart from each other in a circumferential direction of the frame part 21. The frame part 21 and each of the plate members 11 to 13 are jointed by insertion of the dowels D, D into the dowel holes 21a, 21a (see FIG. 4 and FIG. 6 to FIG. 8).

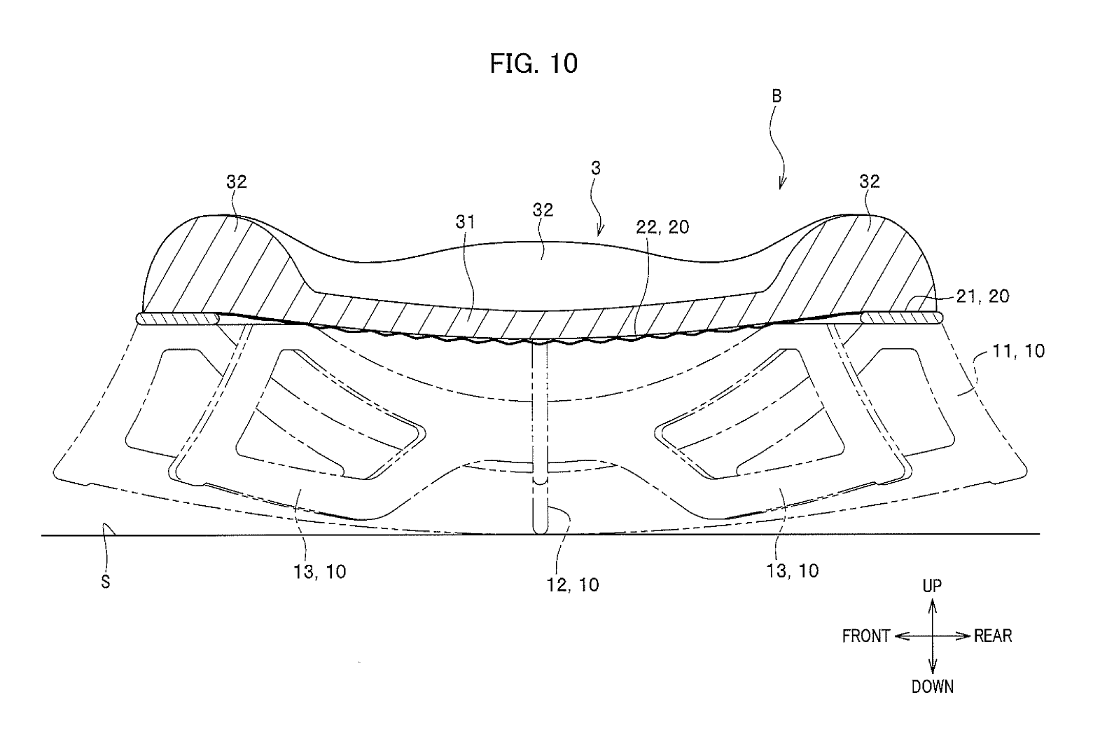

The receive part 22 is primarily a part on which a body of a user lies down. The receive part 22 is made up of plastic (flexible) net-like material. The receive part 22 has a shallow dish-like shape which is concaved (bent) downwardly (see FIG. 10). The receive part 22 is concaved more downwardly than the frame part 21. The receive part 22 in this embodiment is made up of a plurality of paper cords crossed in a longitudinal and a transverse directions (in the front-back and right-left directions). Both ends of each of the paper cords are fixed on the frame part 21. The receive part 22 may be formed by crossing fiber made of rubber, resin, or the like and may be formed into a sheet, a plane, a cloth such as canvas, or the like.

The receive part 22 includes: a crossing portion 22a in which the longitudinal and transverse paper cords are crossed with each other; and four non-crossing portions 22b in which the longitudinal and transverse paper cords do not cross with each other. The crossing portion 22a has a rectangle shape when viewed from above. The non-crossing portion 22b has a substantially arcuate shape surrounded by an arc and a chord. The non-crossing portions 22b are positioned around the crossing portion 22a. The diagonal plate members 13, 13 in the embodiment extend along respective diagonal lines of the crossing portion 22a. The diagonal plate members 13, 13 are fixed onto the frame part 21 at positions off the longitudinal and transverse paper cords.

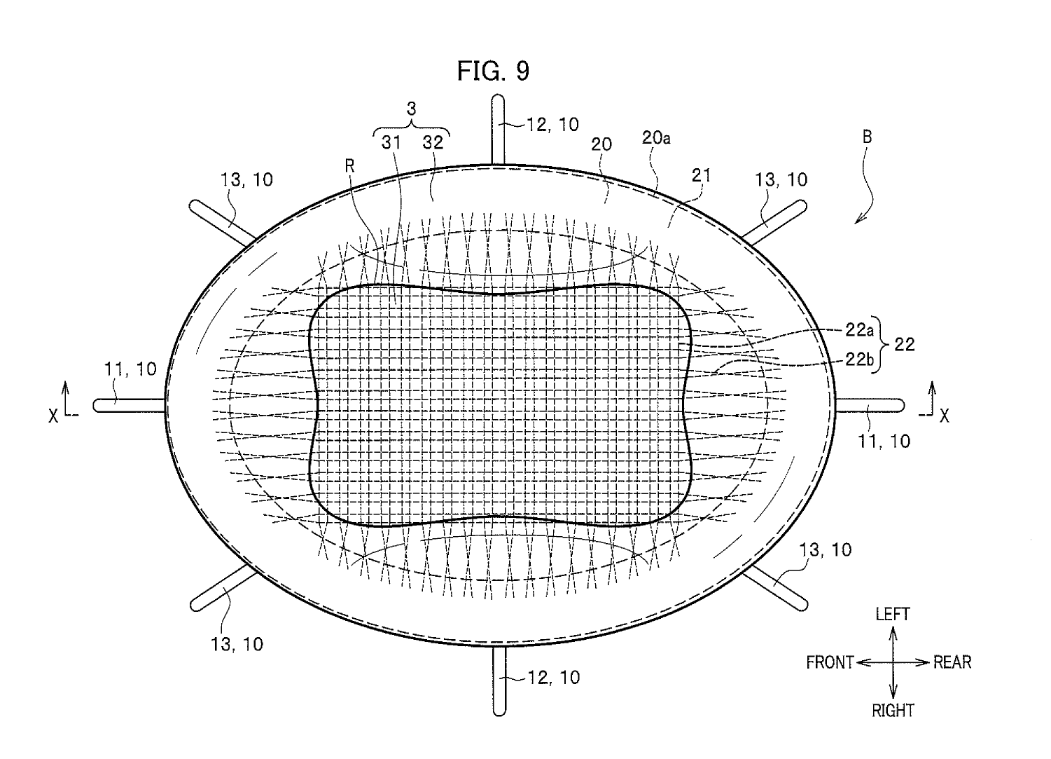

As illustrated in FIG. 9 and FIG. 10, the mattress 3 is placed on the support 20 and has a cushioning property. The mattress 3 has an oval shape substantially same as that of the support 20 when viewed from above. The mattress 3 has a shallow dish-like shape which is concaved downwardly when viewed from a vertical cross section thereof. The mattress 3 is formed by, for example, a cloth cover filled with feathers. The mattress 3 includes: a body section 31; and a pillow section 32 that extends along a whole circumference of the body section 31, which are integrally provided. Note that a bold solid line illustrated in FIG. 9 shows a boundary line R between the body section 31 and the pillow section 32.

The body section 31 is primarily a part on which a trunk of a user lies down. The body section 31 has a substantially rectangle shape when viewed from above. The body section 31 is disposed on the crossing portion 22a.

The pillow section 32 is primarily a part on which at least one of a head, and legs and feet. The pillow section 32 has a substantially oval annular shape when viewed from above. The pillow section 32 is disposed on both the frame part 21 and the non-crossing portion 22b when viewed from above. The pillow section 32 has a substantially same height through the whole periphery. The pillow section 32 may have, however, different heights through the whole periphery.

Dimensions of the bed B are described herein. The dimensions of the bed B are not specifically limited. In the embodiment, for example, the longest dimension of the leg 10 is 1960 mm, the shortest dimension thereof is 1510 mm, and the height dimension thereof is 450 mm. The longest dimension of the support 20 is 1600 mm, and the shortest dimension thereof is 1150 mm. An overall height from the leg 10 to the mattress 3 is within a range from 550 mm to 600 mm.

The bed B in this embodiment basically has the structure as described above. Next are described operations and advantageous effects of the present invention.

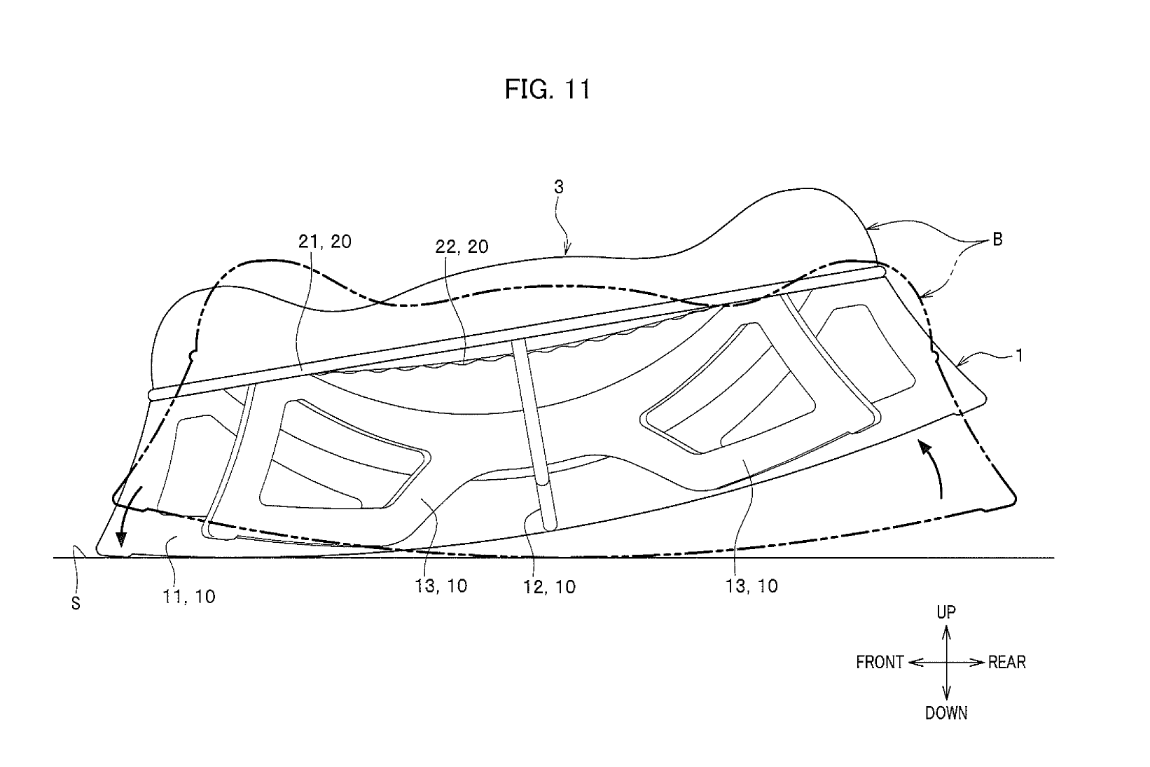

FIG. 11 is a side view of the bed B when viewed from the right-left direction (the minor axis direction). As illustrated in FIG. 11, when a user not shown lies down on the mattress 3 and shifts his/her body center of gravity toward the front side along the lengthwise plate member 11, the entire bed B can be rocked on the front side. When the user shifts his/her body center of gravity toward the rear side along the lengthwise plate member 11, the entire bed B can be rocked on the front side.

Though not shown, when the user shifts his/her body center of gravity in the right and left directions along the crosswise plate member 12, the entire bed B can be rocked in the right and left directions, respectively.

When the user shifts his/her body center of gravity along an oblique direction between the lengthwise plate member 11 and the crosswise plate member 12, the entire bed B can be rocked in the oblique direction.

That is, in this embodiment, the bed B is equipped with the leg 10 which is rockable in a radiation direction, the bed B can be rocked in the radiation direction. This can make the bed B comfortable to sleep.

In this embodiment, the leg 10 includes a plurality of the plate members 11 to 13 which cross with each other. This allows reduction in weight of the leg 10.

In this embodiment, respective both ends of the plate members 11 to 13 are jointed to the frame part 21 which constitutes the periphery of the support 20. This can improve stability of the bed B.

In this embodiment, the chamfered part 11j of each of the lower ends of the plate members 11 to 13 makes line contact with the floor S, thus allowing a contact area between the floor S and each of the plate members 11 to 13 to be smaller. This can prevent the bed B from rattling and achieve a smooth rocking of the bed B.

In this embodiment, the leg 10 extends more outwardly than the circumferential edge 20a of the support 20 when viewed from above. This can prevent the bed B from overturning and improve stability of the bed B.

In this embodiment, the receive part 22 is flexible. This can make the receive part 22 deformable in accordance with a body type or a sleep posture of a user and can thus softly receive the user's body.

In this embodiment, the mattress 3 integrally includes the pillow section 32. This can prevent slippage of the pillow section 32.

In this embodiment, the pillow section 32 extends around the whole circumference of the mattress 3. This makes it easy for a user to sleep with his/her head on the pillow section 32, even when the user changes his/her sleep posture.

As described above, the pillow section 32 extends around the whole circumference of the mattress 3. This makes it possible for a user to put his/her head, and legs and feet on the pillow section 32 such that his/her head, and legs and feet are positioned higher than his/her trunk, thus allowing the user to keep lying in a comfortable position.

In this embodiment, the body section 31 is concaved more downwardly than the pillow section 32. This allows the user's body (trunk) to sink down on the body section 31 and to feel himself/herself being wrapped up, which gives the user sleeping comfort.

In this embodiment, when the contact part 13i comes in contact with the floor S, the contact part 13i makes a bump noise or a rattle. This can call the user's attention.

In this embodiment, the bed B has an oval shape when viewed from above. This allows a tall person to lie on the bed B in the major axis direction, and, in contrast, a short person to lie on the bed B in the minor axis direction. The bed B can be thus used by various users with different body heights and/or different sleep postures.

In this embodiment, the bed B is rockable in the radiation direction. Thus, when a user sits on one side of the pillow section 32 of the bed B, the other side of the bed B is lifted up in such a way as to come close to the user. That is, because the bed B takes such a position to come to receive the user, the user can easily fall himself/herself backwards onto the bed B and lie down thereon.

In this embodiment, the bed frame 1 is made up of only five components, namely: the lengthwise plate member 11; the crosswise plate member 12; a pair of the diagonal plate members 13, 13; and the support 20. The small number of the components allows the bed frame 1 to be easily and quickly assembled or disassembled.

In this embodiment, a pair of the diagonal plate members 13, 13 are not jointed with the lengthwise plate member 11 and the crosswise plate member 12. The number of the joints such as a notched portion can be thus reduced, compared to a structure in which the four plate members 11 to 13 are jointed with each other. This can reduce thin-wall portions of the plate members 11 to 13, to thereby ensure excellent strength and stiffness and prevent the shapes of the plate members 11 to 13 from being complicated.

In this embodiment, the receive part 22 is provided which is made up of a plurality of the paper cords crossed in the longitudinal and the transverse directions (in the front-back and right-left directions). Both ends of each of the paper cords are fixed to the one frame part 21. This makes it possible to distribute and transmit a load applied to the paper cords, to the frame part 21.

Adjustment on how to cross or tie the paper cords makes it possible to suit cushioning property or tension of the receive part 22 to user's preference.

If the receive part 22 is made of net-like material, air permeability can be secured.

In this embodiment, the pillow section 32 has an oval annular shape when viewed from above. This makes it possible to adjust a height, a shape, or softness of the pillow section 32 according to user's preference by circumferentially moving or beating feathers in the pillow section 32.

The embodiment according to the present invention has been explained above in detail with reference to related drawings. The present invention is not, however, limited to those explanations and can be changed within a range not departing from the gist of the present invention.

In the embodiment, the bed B installed on the floor S in a room is described as an example. The bed B can be, however, installed on a ground outdoors, for example.

The present invention can be applied to, for example, a bed for adult, infant, pet, or the like.

In the embodiment, the bed B having an oval shape when viewed from above is described as an example. The bed B may have, however, a circular, polygonal, or any other shape, for example, when viewed from above.

The structure of the leg 10 is not limited to that according to the embodiment, and may be changed where appropriate.

In the embodiment, the leg 10 has the structure composed of a plurality of the plate members 11 to 13. The leg 10 may have, however, a hemispherical structure. The contact member of the leg 10 may have a bar or a frame shape made of wood, metal, resin, or the like. That is, the leg 10 may have any shape and may be made of any material, as long as the leg 10 can be rocked in the radiation direction.

In the embodiment, the diagonal plate members 13, 13 are crossed with the lengthwise plate member 11 at an angle different from that with the crosswise plate member 12. However, the plate members 11 to 13 may be crossed at equal angles in the circumferential direction.

In the embodiment, the lengthwise plate member 11 and the crosswise plate member 12 are provided. The plate member 11, 12 may not be, however, provided, and only a pair of the diagonal plate members 13, 13 may be provided.

In the embodiment, a pair of the diagonal plate members 13, 13 are provided. The plate members 13, 13 may not be, however, provided, and only the lengthwise plate member 11 and the crosswise plate member 12 may be provided. With the structures described above, the number of the plate members is reduced, which can enhance rocking of the bed B. In this case, a stable operation of the bed B can be obtained by making the projected dimension L1 of the lengthwise plate member 11 and the projected dimension L2 of the crosswise plate member 12 longer.

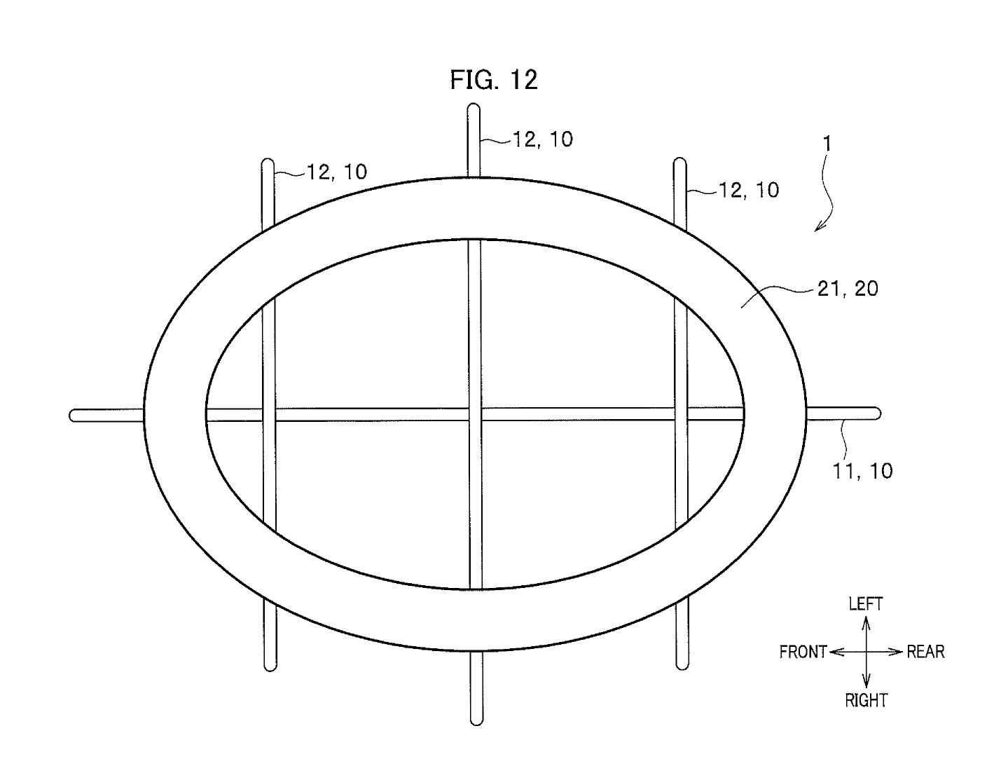

In the embodiment, a pair of the diagonal plate members 13, 13 are provided. The diagonal plate members 13, 13 may not be, however, provided and, as illustrated in FIG. 12, a plurality of the crosswise plate members 12 (three in this variation) may instead be provided. Note that, for convenience of explanation, the receive part 22 is not illustrated in FIG. 12. A plurality of the crosswise plate members 12 extend in parallel to one another. A plurality of the crosswise plate members 12 are disposed equally spaced apart in the front-back direction (the major axis direction).

In the embodiment, each of the lower ends of the plate members 11 to 13 makes line contact with the floor S. Each of the lower ends may, however, make plane contact with the floor S.

In the embodiment, the outer ends of the plate members 11 to 13 are positioned more outwardly than the circumferential edge 20a of the support 20 when viewed from above. The outer ends may be, however, positioned neither outwardly nor inwardly, or more inwardly than the circumferential edge 20a when viewed from above.

In the embodiment, the plate members 11 to 13 include the upper diagonal parts 11c, 12c, 13c, respectively. The upper diagonal parts 11c, 12c, 13c may not be, however, provided.

In the embodiment, the plate members 11 to 13 include the contact parts 11i, 12i, 13i, respectively, which are formed in planar shapes. The contact parts 11i, 12i, 13i may be, however, formed in protrusion or any other shapes. Or, the contact parts 11i, 12i, 13i may not be provided.

In the embodiment, the plate members 11 to 13 include the bored-out holes 11g, 12g, 13g, respectively. The bored-out holes 11g, 12g, 13g may not be, however, provided.

In the embodiment, each of the outer ends of the outer parts 11e, 12e, 13e is formed in the arcuate shape with the inward convex. Each of the outer ends may be, however, formed in a planar shape.

In the embodiment, the dowel D is used for jointing the frame part 21 to each of the plate members 11 to 13. A screw or the like may be used instead.

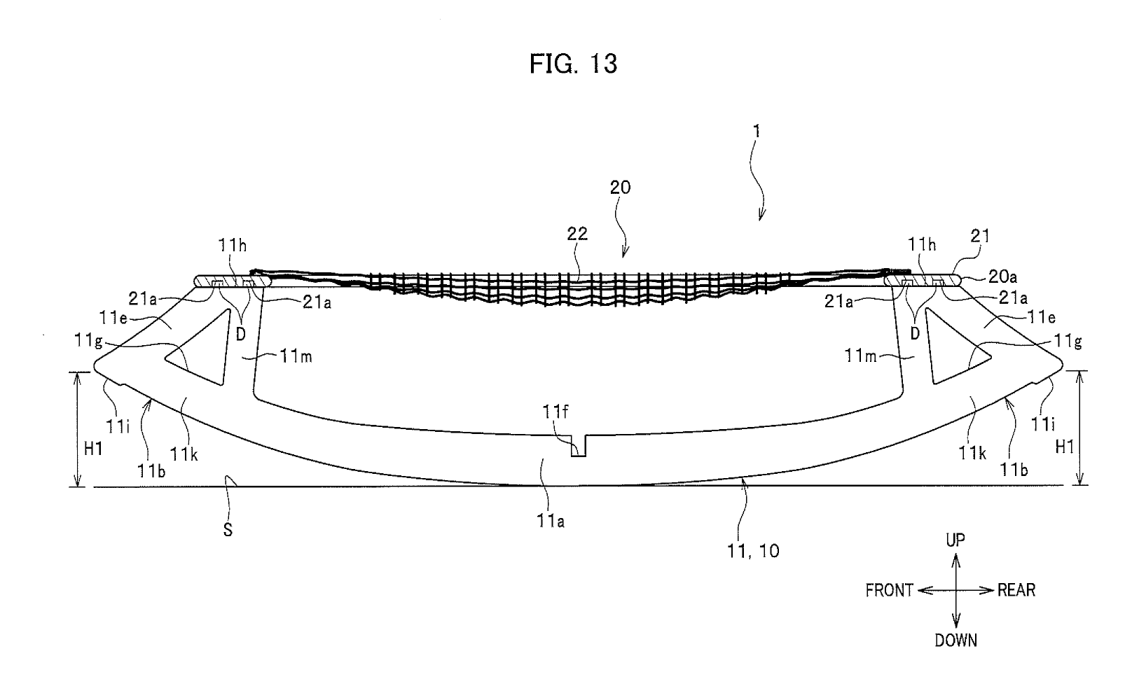

The structure of the lengthwise restriction part 11b may be changed as illustrated in FIG. 13, together with making a curvature of the lengthwise plate member 11 as a whole larger than that of the embodiment. In the explanation below, the same reference numerals are given to components of the structure same as those of the embodiment, and such a description which is otherwise duplicated is omitted herefrom.

In a variation as illustrated in FIG. 13, each of a pair of the lengthwise restriction parts 11b, 11b includes; an inclined part 11k that extends outwardly and obliquely upwardly from the outer end of the lengthwise base part 11a around a part of the bored-out hole 11g; the outer part 11e that extends inwardly and obliquely upwardly from an outer end of the inclined part 11k; and a connection part 11m that connects the inclined part 11k and the outer part 11e.

The more outwardly, the more upwardly the inclined part 11k is inclined. The outer end of the inclined part 11k is positioned more outwardly than the circumferential edge 20a of the frame part 21 when viewed from above. A lower end of the inclined part 11k and the lower end of the lengthwise base part 11a are integrally connected without irregularities therebetween and are formed in an arcuate shape with a downward convex as a whole.

The outer part 11e extends at first obliquely upwardly from the outer end of the inclined part 11k toward the frame part 21, and then extends horizontally and inwardly. The contact part 11i is formed on the lower end of the outer part 11e and protrudes in a step shape more downwardly than the inclined part 11k.

The connection part 11m extends between the inclined part 11k and the outer part 11e in the up-down direction. The connection part 11m enhances strength of the outer part 11e. Note that the connection part 11m may not be provided.

In this variation, the curvature of the lengthwise plate member 11 as a whole is made larger than that of the embodiment. That is, the more outwardly, the larger a distance between the lower end of the lengthwise base part 11a and the lower end of the inclined part 11k, compared to the distance according to the embodiment. The height dimension H1 from the floor S to the contact part 11i is made larger than the dimension described in the embodiment as an example (100 mm). The structure of this variation can be applied to the other plate members 12, 13.

In the embodiment, the receive part 22 is formed in the shallow dish-like shape which is concaved downwardly. The receive part 22 may be, however, formed in a planar shape.

In the embodiment, the support 20 is composed of the frame part 21 and the receive part 22. The support 20 may be, however, composed of a single plate or a bar-like member. In this case, the plate members 11 to 13 may be jointed to a portion other than the periphery (for example, a central portion) of the support 20.

In the embodiment, the support 20 is composed of the frame part 21 and the receive part 22 as described above. The frame part 21 may be, however, composed of only the receive part 22.

In the embodiment, the pillow section 32 is provided along the whole periphery of the body section 31. The pillow section 32 may be, however, provided along a part of the periphery of the body section 31 (for example, half a periphery).

1. A bed frame, comprising:
a leg that can be rocked in a radiation direction; and
a support that is connected onto the leg and supports a body of a user.

2. The bed frame according to claim 1,
wherein the leg comprises a plurality of contact members that cross each other, each of which comes into contact with a surface on which the bed frame is installed, and
wherein at least a periphery of the support is connected to each of the contact members.

3. The bed frame according to claim 2,
wherein each of respective lower ends of the contact members makes line contact with the installation surface.

4. The bed frame according to claim 1,
wherein the leg extends more outwardly than a circumferential edge of the support when viewed from above.

5. The bed frame according to claim 1,
wherein the support comprises:
a frame part that is connected to the leg; and
a receive part that is disposed inside the frame part, is concaved more downwardly than the frame part, and is flexible.

6. A bed, comprising:
the bed frame according to claim 1; and
a mattress that is placed on the support of the bed frame,
wherein the mattress has a shape substantially same as that of the support when viewed from above, and
wherein the mattress comprises: a body section; and a pillow section that extends along a periphery of the body section.

7. A bed, comprising:
the bed frame according to claim 2; and
a mattress that is placed on the support of the bed frame,
wherein the mattress has a shape substantially same as that of the support when viewed from above, and
wherein the mattress comprises: a body section; and a pillow section that extends along a periphery of the body section.

8. A bed, comprising:
the bed frame according to claim 3; and
a mattress that is placed on the support of the bed frame,
wherein the mattress has a shape substantially same as that of the support when viewed from above, and
wherein the mattress comprises: a body section; and a pillow section that extends along a periphery of the body section.

9. A bed, comprising:
the bed frame according to claim 4; and
a mattress that is placed on the support of the bed frame,
wherein the mattress has a shape substantially same as that of the support when viewed from above, and
wherein the mattress comprises: a body section; and a pillow section that extends along a periphery of the body section.

10. A bed, comprising:
the bed frame according to claim 5; and
a mattress that is placed on the support of the bed frame,
wherein the mattress has a shape substantially same as that of the support when viewed from above, and
wherein the mattress comprises: a body section; and a pillow section that extends along a periphery of the body section.
